(19) United States
(12) Patent Application Publication
(10) Pub. No.: US 2001/0050048 A1
(43) Pub. Date: Dec. 13, 2001

(54) Tank for accommodating a fluid used for the surface treatment of work pieces

(75) Inventors: Rolf Gutjahr, Ditzingen (DE); Edmund Krannich, Heimsheim (DE)

Correspondence Address: LAW OFFICE OF BARRY R LIPSITZ, 755 MAIN STREET, MONROE, CT, 06468, US

(73) Assignee: Duerr Systems GmbH, Stuttgart (DE)

(21) Appl. No.: 09/848,611

(22) Filed: May 3, 2001

(30) Foreign Application Priority Data
May 11, 2000 (DE) 100 23 024.5

(51) Int. Cl. B05C 13/00

(52) U.S. Cl. 118/501

(57) ABSTRACT

In order to produce a tank for accommodating a fluid used for the surface treatment of work pieces, especially vehicle bodies, wherein the fluid accommodated in the tank can be kept free of dirt particles with little outlay, it is proposed that the tank comprise dirt collecting compartments which are arranged in the base region of the tank.

The invention relates to a tank for accommodating a fluid used for the surface treatment of work pieces, and especially of vehicle bodies.

Such types of tank are employed, in particular, in vehicle body painting plants for the purposes of pretreating or dip coating vehicle bodies.

In order to remove dirt particles, which are introduced into the fluid bath in the respective tank by the vehicle bodies being treated therein, from the fluid bath, it is known to provide such tanks with a circulating system including a filter through which the fluid in the bath is pumped by means of a fluid pump whereby the dirt particles will be deposited from the bath onto the filter.

However, it is a disadvantage of the known tanks incorporating a circulating system that the filters need frequent cleaning or replacement, and that a large amount of energy is required for operating the circulating system because of the pressure loss in the filter.

Moreover, there is a danger that the dirt particles that have sedimented onto the base of the tank will be whirled up within the bath due to turbulences in the flow so that this can lead to the bath becoming dirty again.

Consequently, the object of the invention is to produce a tank for accommodating a fluid used for the surface treatment of work pieces, especially vehicle bodies, wherein the fluid accommodated in the tank can be kept free of dirt particles with little outlay.

In accordance with the invention, this object is achieved in the case of a tank having the features mentioned in the first part of claim 1 in that the tank comprises dirt collecting compartments which are arranged in the base region of the tank.

The inventive solution is based upon the concept of removing the dirt particles, which are contained in the fluid accommodated in the tank, from this fluid by means of a process of sedimentation into the dirt collecting compartments at the base of the tank, whereby, in contrast to a process of sedimentation of the dirt particles onto the base of a tank not provided with the dirt collecting compartments, a renewed dirtying of the tank due to the flow of fluid therethrough can then be ruled out because the dirt particles have collected in the dirt collecting compartments and have thereby been removed from the effects of the fluid flow.

After draining the fluid from the tank, the dirt that has collected in the dirt collecting compartments can be removed from the tank at regular intervals either by cleaning the dirt collecting compartments or by removing the dirt collecting compartments together with the dirt particles contained therein from the tank.

In particular, the tank in accordance with the invention may be in the form of a dip tank for immersing the work pieces, especially the vehicle bodies. Such a tank enables the work pieces to be pretreated in a pretreatment bath for example.

As an alternative thereto, provision may also be made for the tank in accordance with the invention to be in the form of a return tank for a dip tank through which the fluid contained in the dip tank is continuously or discontinuously circulated. Such a return tank may serve for continuously cleaning the fluid in the dip tank by means of a process of sedimentation into the dirt collecting compartments in the return tank. As an alternative or in addition thereto, the return tank may be used for temporarily storing the fluid accommodated in the dip tank when the fluid has to be drained from the dip tank for the purposes of maintenance work on the dip tank.

In one preferred embodiment of the invention, provision is made for the dirt collecting compartments to be bounded by boundary walls extending transversely to the longitudinal direction of the tank. Such boundary walls serve for braking the flow and preventing dirt that has been collected in the dirt collecting compartments from being carried back into the fluid bath above the dirt collecting compartments by virtue of turbulences occurring in the flow.

It is particularly expedient if the boundary walls are in the form of partition walls which respectively separate two mutually successive dirt collecting compartments in the longitudinal direction of the tank. Each boundary wall in the form of a partition wall between two dirt collecting compartments thereby simultaneously bounds two dirt collecting compartments so that the number of boundary walls that are needed for forming the dirt collecting compartments and which serve as a means for braking the flow will be reduced.

In a preferred embodiment of the invention, provision is made for the boundary walls to comprise an upper portion which is inclined to the horizontal and inclined to the vertical.

By virtue of the fact that the upper portion of the boundary walls is inclined to the horizontal, it is ensured that dirt particles will not sediment from the fluid bath in the tank onto the upper face of the upper portion of the boundary walls from where they could be conveyed back into the fluid bath by the flow.

By virtue of the fact that the upper portion of the boundary walls is inclined to the vertical, it is ensured that the flow through the fluid bath cannot penetrate into the dirt collecting compartments and thereby create vortices therein by means of which dirt particles could enter the fluid bath from the dirt collecting compartments.

It has proved to be expedient if the upper portion is inclined to the horizontal at an angle of approximately 20° to approximately 80°, preferably at an angle of approximately 30° to approximately 70°, and especially at an angle of approximately 40° to approximately 60°.

In simulations of the flow conditions in the fluid bath, it has proved to be particularly expedient to have an angle of approximately 60° between the upper portion of the boundary walls and the horizontal.

Furthermore, it is particularly expedient if the upper portion of the boundary walls is aligned against the mean direction of flow in the fluid bath.

Furthermore, it is advantageous if the boundary walls comprise a vertical lower portion.

These boundary walls may be fixed to the base of the tank, by means of welding for example.

As an alternative thereto, provision may be made for the boundary walls to be releasably attached to the base of the tank. This has the advantage that the boundary walls can easily be replaced in the event that they should be damaged or in case the manner of operation of the tank is to be altered, especially if the mean direction of flow through the tank should be changed or the average speed of the flow should be altered in accordance with the magnitude thereof.

In particular, the boundary walls could be releasably attached to the base of the tank if the tank comprises mountings into which the boundary walls are insertable.

In a preferred embodiment of the invention, provision is made for the tank to be provided with a dirt collecting compartment body which comprises the boundary walls and connecting elements by means of which the boundary walls are connected together. It is thereby possible to introduce the dirt collecting compartments bounded by the boundary walls

into the tank, or, to remove them from the tank, as an entire unit.

It is particularly expedient if the dirt collecting compartment body comprises a base. The mechanical stability of the dirt collecting compartment body is thereby increased. Moreover, dirt particles do not sediment onto the base of the tank in this case, but rather, onto the base of the dirt collecting compartment body so that the base of the tank remains free from dirt.

Furthermore, if provision is advantageously made for the dirt collecting compartment body to be removable from the tank, then the dirt collecting compartment body does not have to be cleaned of the dirt sedimented therein whilst it is still in the tank, but the dirt can be removed together with the dirt collecting compartment body from the tank and the cleaning process can be carried out outside the tank thus shortening the maintenance periods for the tank such as are required for cleaning purposes.

The dirt collecting compartment body may be made of steel for example.

In a preferred design, the dirt collecting compartment body is made of a synthetic material, for example, of polyvinyl chloride or polypropylene. Such a dirt collecting compartment body is of very low weight and can be produced, by means of an injection moulding process for example, at lower cost than a metallic dirt collecting compartment body.

Removal of the sedimented dirt from the dirt collecting compartment body can be dispensed with completely if the dirt collecting compartment body is made of a disposable material so that the dirt collecting compartment body can be disposed of together with the dirt collected therein.

If, advantageously, the dirt collecting compartment body comprises a flexible material, for example, polyamide, then the dirt collecting compartment body can be rolled up for easy and space-saving transportation thereof.

Nevertheless, in order to be able to ensure the effectiveness of the boundary walls as flow brakes in the fluid bath in the tank, provision may, for example, be made for the dirt collecting compartment body to comprise a base consisting of a flexible material and dimensionally stable boundary walls consisting of polyethylene for example.

As an alternative or in addition thereto, provision may be made for the dirt collecting compartment body to comprise a support frame consisting of polyethylene for example.

A dirt collecting compartment body that is designed to be rolled up is transportable in a particularly simple manner.

Furthermore, provision may be made for the dirt collecting compartment body to be in the form of a flexible belt and for the tank to comprise a movement inducing device for moving the dirt collecting compartment body through the tank. In this case, the dirt collecting compartment body can be gradually moved through the base region of the tank and be loaded, section-by-section, with the dirt that has sedimented

from the fluid bath in the tank, whereby the regions of the dirt collecting compartment body that are now loaded with dirt can be gradually moved out of the tank so that the removal of the sedimented dirt from the tank will be effected continuously and it will no longer be necessary to stop usage of the tank in order to drain the fluid from the tank.

An embodiment of the invention that is particularly economical is one wherein the dirt collecting compartment body is in the form of an endless belt. By virtue of such an embodiment, the regions of the dirt collecting compartment body that have been moved out of the tank are cleaned by emptying the dirt from the dirt collecting compartments and then they are returned to the tank whereby continuous operation of the tank using only a small amount of material is possible.

The claims 23 to 37 are directed to a dirt collecting compartment body for a tank for accommodating a fluid used for the surface treatment of work pieces, and especially of vehicle bodies, which implements the selfsame inventive idea as the tank in accordance with the invention.

The advantages of the subject matters of claims 23 to 37 have already been explained hereinabove in connection with the special embodiments of the tank in accordance with the invention.

Further features and advantages of the invention form the subject matter of the following description and the sketched illustration of the embodiments. In the drawings

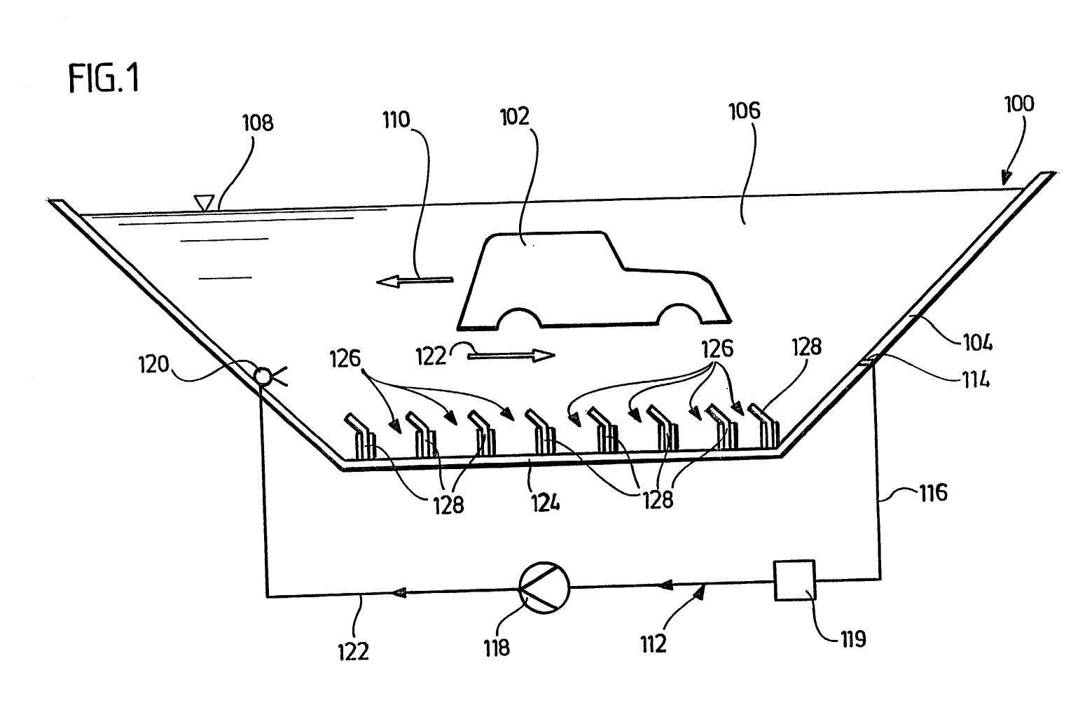

FIG. 1 shows a schematic longitudinal section through a dip tank used for the surface treatment of vehicle bodies having dirt collecting compartments arranged in the base region of the dip tank;

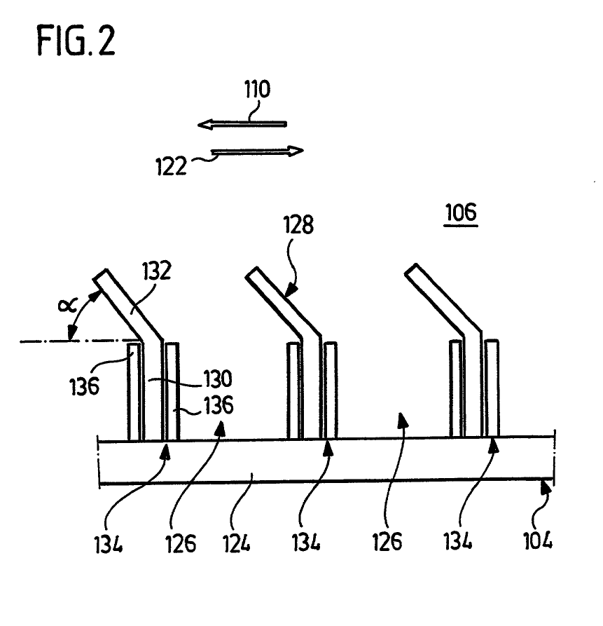

FIG. 2 a schematic section through a first embodiment of the dirt collecting compartments which comprise boundary walls that are insertable into mountings at the base of the dip tank;

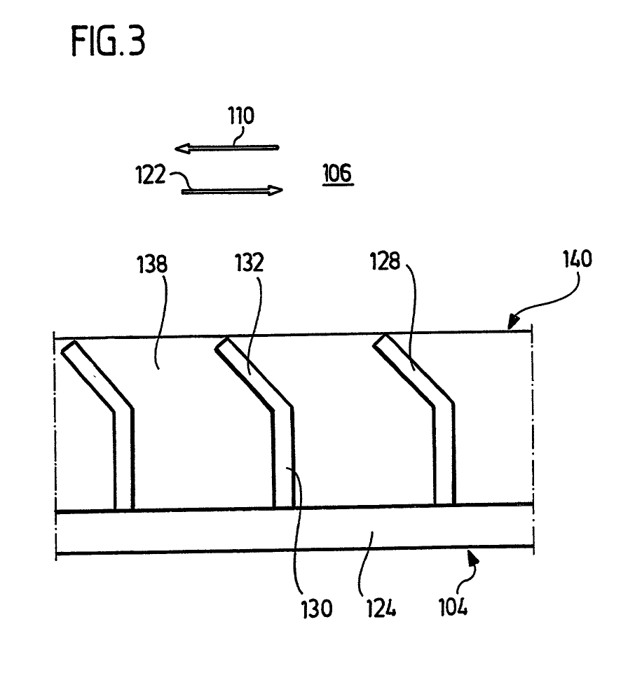

FIG. 3 a schematic section through the dirt collecting compartments of a second embodiment which comprise boundary walls that are component parts of a collecting compartment body;

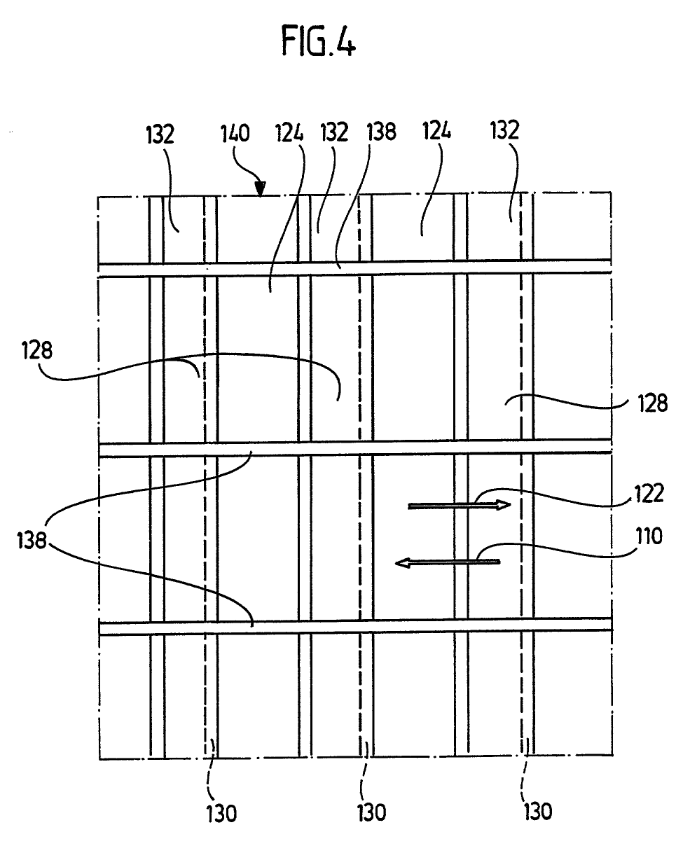

FIG. 4 a schematic sectional top view of the collecting compartments in FIG. 3;

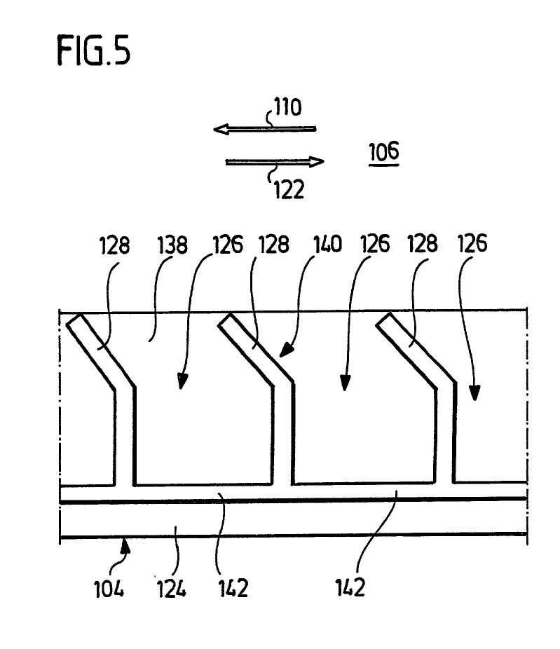

FIG. 5 a schematic section through the dirt collecting compartments of a third embodiment which comprise a base and boundary walls that are component parts of a dirt collecting compartment body;

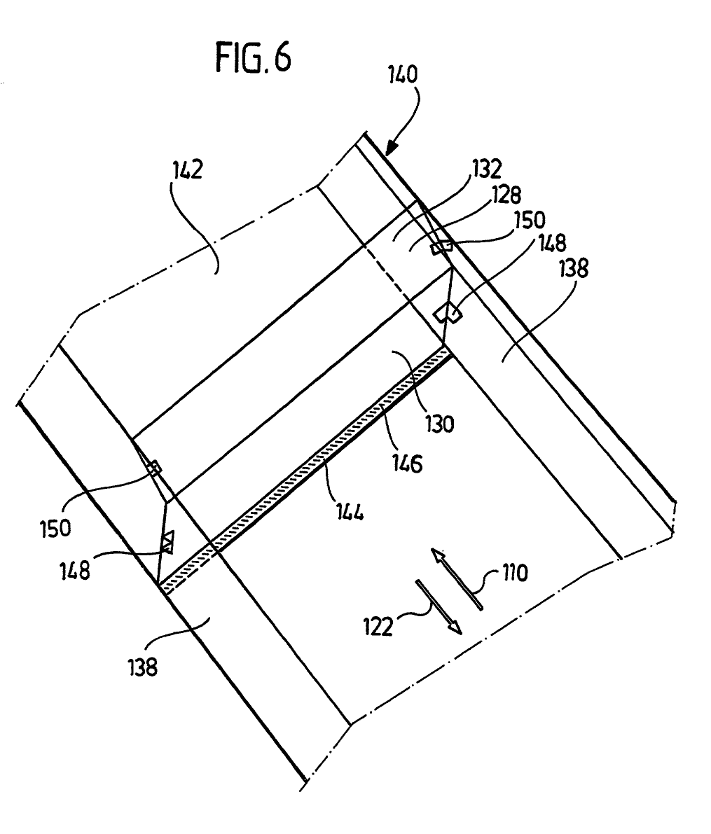

FIG. 6 a schematic perspective view of the dirt collecting compartments of a fourth embodiment which comprise boundary walls made of polyethylene and a base made of polyamide;

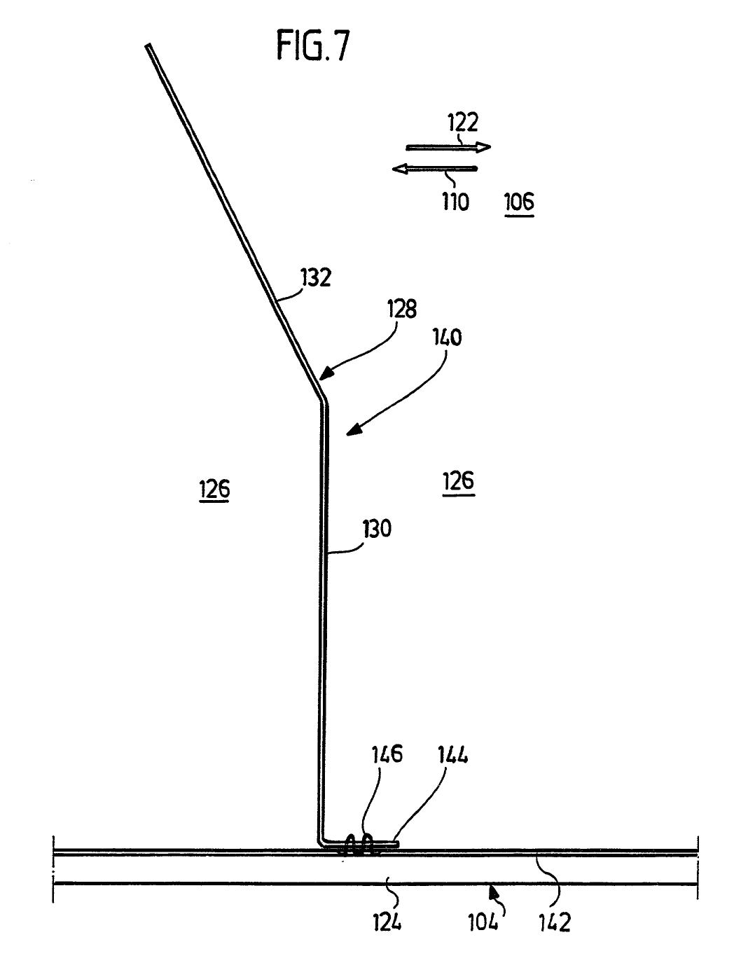

FIG. 7 a schematic section through the dirt collecting compartments of FIG. 6;

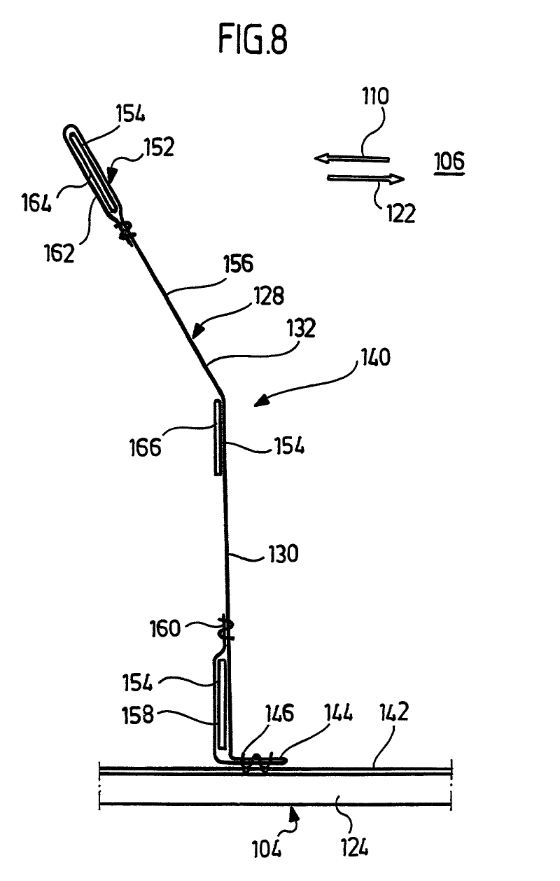

FIG. 8 a schematic section through the dirt collecting compartments of a fifth embodiment which comprise boundary walls made of polyamide having a support frame made of polyethylene and also a base made of polyamide; and

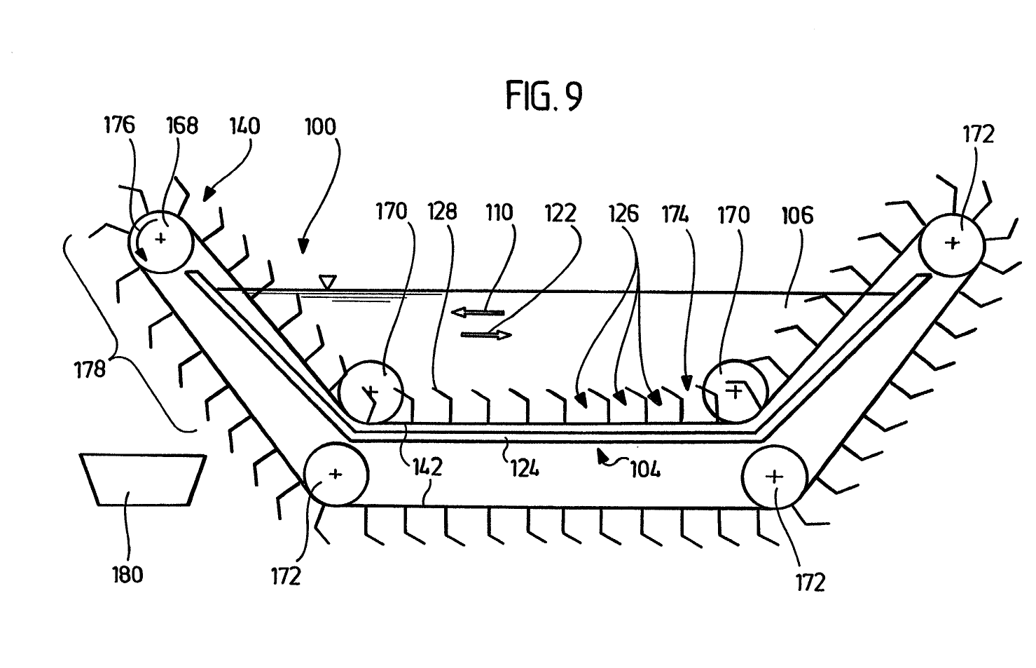

FIG. 9 a schematic longitudinal section through a dip tank for the surface treatment of vehicle bodies which is provided with dirt collecting compartments arranged in the base region of the dip tank, wherein the base and the boundary walls are component parts of a dirt collecting compartment body in the form of an endless belt.

The same or functionally equivalent elements are provided with the same references in each of the FIGS.

A dip tank 100 used for the surface treatment of vehicle bodies 102 is schematically illustrated in FIG. 1 in the form of a longitudinal section and it comprises a trough 104 which is filled with a bath 106 of a fluid for the surface treatment of the vehicle bodies 102 up to a fluid level 108.

The vehicle bodies 102 are adapted to be immersed in the bath 106 by means of a (not illustrated) conveyor device located at one end (to the right in the illustration of FIG. 1) of the dip tank 100, said bodies being movable through the bath 106 in a direction of passage 110 and being removable from the bath 106 at another end (to the left in the illustration of FIG. 1).

Furthermore, the dip tank 100 comprises a circulating system 112 which comprises a fluid outlet 114 that is connected via a fluid removal line 116 to the suction side of a fluid pump 118, and an inlet nozzle 120 that is connected via a fluid supply line 122 to the pressure side of the fluid pump 118.

A filter 119 is arranged in the fluid removal line 116.

A fluid flow is producible by means of the inlet nozzle 120 (or a plurality of inlet nozzles 120 if necessary), the flow through the bath 106 being along a substantially horizontally aligned mean direction of flow 122. Hereby, the average speed of the stream preferably amounts to 0.2 m/s±0.2 m/s.

In a preferred embodiment of the dip tank 100, the direction of flow 122 is in parallel with but opposed to the direction of passage 110 of the vehicle bodies 102 through the bath 106.

A plurality of dirt collecting compartments 126, which extend over the entire width of the base 124 and are perpendicular to the direction of passage 110, are formed in the region of the base 124 of the trough 104 and succeed one another in the direction of passage 110, whereby each of the dirt collecting compartments 126 is bounded at the bottom by the base 124 of the trough 104 and—as seen in the direction of passage 110—they are bounded to the front and to the rear by boundary walls 128 which extend substantially perpendicularly to the direction of passage 110.

The boundary walls 128 are in the form of partition walls which separate two successive dirt collecting compartments 126 from one another along the direction of passage 110 of the vehicle bodies 102 through the dip bath 106.

The detailed construction of the boundary walls 128 can best be appreciated from the sectional illustration in FIG. 2.

As is apparent from FIG. 2, each of the boundary walls 128 comprises a vertical lower portion 130 and an inclined upper portion 132 which is inclined to the horizontal upper surface of the base 124 at an angle a of approximately 20° to approximately 80°, and especially at an angle of approximately 30° to approximately 70°, namely, in such a manner that the inclined upper portion 132 of the boundary wall 128 is directed against the direction of flow 122.

An angle α of approximately 60° has proved to be particularly expedient in simulations of the flow conditions in the bath 106.

The preferred height of the vertical lower portion 130 of the boundary walls 128 amounts to approximately 10 cm.

The preferred prolongation of the inclined upper portion 132 of the boundary walls 128 in the vertical direction amounts to approximately 8 to approximately 9 cm.

The upper edge of the inclined upper portion 132 of the boundary walls 128 lies at least approximately 40 cm lower than the inlet nozzle 120 and the fluid outlet 114.

The preferred spacing between two successive boundary walls 128 along the direction of passage 110 amounts to approximately 10 cm.

The vertical lower portions 130 of the boundary walls 128 are each inserted into a mounting 134 which, for its part, is fixed to the base 124 of the trough 104.

Each mounting 134 may, for example, comprise two mounting strips 136 which extend over the entire width of the base 124 and project vertically upwards from the upper surface of the base 124 such that they are perpendicular to the direction of passage 110, said two mounting strips being spaced from one another along the direction of passage 110 by a distance which is slightly greater than the thickness of the vertical lower portion 130 of a boundary wall 128 so that each boundary wall 128 is held with only a very small amount of play between the two parallel mounting strips 136 of the mounting 134.

The mounting strips 136 are fixed to the base 124 in an appropriate manner, by means of welding for example.

Rather than being inserted into a respective mounting 134, the vertical lower portions 130 of the boundary walls 128 could also be firmly attached to the respective mounting 134, by means of welding for example.

However, insertion of the boundary walls 128 into the mounting 134 offers the advantage that the boundary walls 128 can easily be replaced in case they should be damaged, or if the manner in which the dip tank 100 is operated should be altered, especially if the mean direction of flow 122 is to be changed or the average speed of the flow should be altered in accordance with the magnitude thereof. In such a case, the boundary walls 128 can be removed from the mountings 134 and reinserted with the opposite orientation, or be replaced by other boundary walls 128 whose inclined upper portion 132 includes a different angle a with the upper surface of the base 124.

The effect produced by the dirt collecting compartments 126 formed by the boundary walls 128 in the base region of the dip tank 100 is that dirt particles, which are introduced into the dip bath 106 by the vehicle bodies 102 for example, will sink down from the dip bath 106 into the dirt collecting compartments 126 and sediment therein without it being possible for them to be reintroduced into the dip bath 106 and thereby dirty it again as a result of the flow therethrough since the boundary walls 128 of the dirt collecting compartments 126 function as flow brakes and prevent the dirt particles from being extracted from the dirt collecting compartments 126.

The inclined upper portions 132 of the boundary walls 128 are inclined to the horizontal at an angle a which is sufficient to ensure that the dirt particles will not sediment out of the bath 106 onto the upper surface of these inclined upper portion 132 from where they could be conveyed back into the bath 106 by the flow.

On the other hand, the inclined upper portions 132 of the boundary walls 128 are also inclined to the vertical by an amount which is sufficient to prevent the flow through the bath 106 penetrating into the dirt collecting compartments 126 and thus producing vortices in the dirt collecting compartments 126 by means of which the dirt particles could re-enter the bath 106 from the dirt collecting compartments 126.

The dirt that has sedimented into the dirt collecting compartments 126 is removed during the cleaning of the dip tank 100, this occurring at regular intervals of one to eight months for example, after the fluid has been drained from the dip tank 100.

The boundary walls 128 of the dirt collecting compartments 126 have a very efficient moderating effect upon the bath 106 in the base region thereof without involving any particularly great constructional outlay.

Due to the sedimentation of the dirt particles into the dirt collecting compartments 126 in the base region of the dip tank 100, the bath 106 is kept substantially free of dirt particles so that a lesser quantity of dirt will collect in the filter 119 in the circulating system 112 whereby the pressure loss occurring in the filter 119 will then be smaller so that the power of the fluid pump 118 that is required for maintaining the circulating system 112 will also be less.

Moreover, the filter 119 has to be cleaned less frequently; if disposable filters are used then these will need replacing less frequently.

In dependence upon the type of work pieces being treated and in dependence on the demands made in respect of cleanliness of the bath 106, cleaning of the bath 106 via the circulating system 112 could be completely dispensed with in certain circumstances thereby saving the need for the circulating system 112.

Even currently existing dip tanks 100 could be provided with the boundary walls 128 in a simple manner in order to form the collecting compartments 126 in the base region of the respective dip tank 100.

A second embodiment of the dirt collecting compartments 126 which is illustrated in FIGS. 3 and 4 is formed by boundary walls 128 which are not held on the base 124 of the dip tank 100 by a mounting means, but rather these boundary walls, together with side walls 138 which extend substantially perpendicularly to the boundary walls 128 and which are substantially parallel to the direction of passage 110, form a composite dirt collecting compartment body 14 which rests on the base 124 of the dip tank 100 so that, in this case, the dirt collecting compartments 126 are bounded laterally by the boundary walls 128 and the side walls 138 of the dirt collecting compartment body 140 and, at the bottom, by the base 124 of the trough 104.

Otherwise, the dirt collecting compartments 126 of the second embodiment correspond exactly to the dirt collecting compartments 126 of the first embodiment in regards to their construction and manner of functioning, so that reference may be made in these respects to the preceding description.

The dirt collecting compartments 126 of the third embodiment illustrated in FIG. 5 differ from the dirt collecting compartments 126 of the second embodiment in that they are formed by a dirt collecting compartment body 140 which comprises its own base 142 in addition to the boundary walls 128 and the side walls 138, whereby said base of the dirt collecting compartment body 140 rests on the base 124 of the trough 104.

This embodiment offers the advantage that the dirt collecting compartments 126 do not have to be emptied individually during the cleaning process, but rather, the dirt collecting compartment body 140 together with the dirt that has collected by sedimentation onto the base 142 of the dirt collecting compartment body 140 can be removed from the trough 104 in the manner of a basket so that the dirt collecting compartment body 140 can be emptied-out outside the dip tank 100.

The time required for cleaning the dip tank 100 can be considerably reduced in this case by virtue of the fact that the dirt collecting compartment body 140 laden with dirt is replaced by a cleaned dirt collecting compartment body 40, whereby the dirt laden dirt collecting compartment body 140 can be cleansed of the dirt contained therein outside the dip tank 100 at a later time point whereafter the cleaned dirt collecting compartment body 140 can be reinserted into the original dip tank 100 or into another dip tank 100.

Furthermore, it is also possible to manufacture the dirt collecting compartment body 140 from a disposable material and to dispose of the dirt collecting compartment body 140 together with the sediment of dirt therein after the removal thereof from the dip tank 100.

Otherwise, the third embodiment of the dirt collecting compartments 126 corresponds exactly to the second embodiment in regards to the construction and manner of functioning

thereof, so that reference may be made in these respects to the preceding description.

A fourth embodiment of the dirt collecting compartments 126 which is illustrated in FIGS. 6 and 7 differs from the previously described third embodiment in that the base 142 and the side walls 138 of the dirt collecting compartment body 140 are not made of a dimensionally stable material but rather they are made from a flexible material, for example, from polyamide.

The boundary walls 128 of the dirt collecting compartment body 140 of the fourth embodiment consist of a dimensionally stable material, of polyethylene for example, and, apart from the inclined upper portion 132 and the vertical lower portion 130, they additionally comprise a fixing strip 144 which projects in the horizontal direction from the lower edge of the vertical lower portion 130 and is connected to the base 142 of flexible material by being sewn thereto by means of a sewing material 146.

In order to simplify the process of sewing it to the base 142, the fixing strip 144 could be provided with perforations through which a thread of the sewing material 146 could be threaded.

For the purposes of stabilising the position of the boundary wall 128, the lower vertical portion 130 of each boundary wall 128 is connected, at each of its edges adjoining a respective one of the side walls 138, to the relevant side wall 138 of flexible material, of polyamide fabric for example, by means of suitable connecting elements 148 which could be in the form of Velcro fasteners or press studs for example.

In like manner, the inclined upper portion 132 of each boundary wall 128 is connected, at each of its edges adjoining a respective one of the side walls 138, to the relevant side wall 138 by means of connecting elements 150 which could likewise be in the form of Velcro fasteners or press studs for example.

The side walls 138 are sewn to the base 142 of the dirt collecting compartment body 140 at their lower edges.

The dirt collecting compartment body 140 of the fourth embodiment can easily be cut to the length required for the respective dip tank 100 and can be rolled up for transportation purposes because of the flexibility of the base 142 and the side walls 138.

The thickness of the boundary walls 128 made of dimensionally stable material, of polyethylene for example, preferably amounts to approximately 0.8 mm to approximately 1 mm.

The flexible material from which the base 142 and the side walls 138 of the dirt collecting compartment body 140 are made may be in the form of a woven material for example.

The mesh of such a woven material should be less than approximately 5 μm in order to provide it with an adequate ability to retain the dirt particles and moderate the flow through the bath 106.

Otherwise, the fourth embodiment of the dirt collecting compartments 126 corresponds exactly to the third embodiment in regard to the construction and manner of functioning thereof, so that reference may be made in these respects to the preceding description.

A fifth embodiment of the dirt collecting compartments 126 which is illustrated in FIG. 8 differs from the previously described fourth embodiment in that the boundary walls 128 of the dirt collecting compartment body 140 are not made entirely of a dimensionally stable material such as polyethylene for example, but rather, they each comprise a support frame 152 consisting of support strips 154 extending parallel to the boundary walls 128 and perpendicularly to the direction of passage 110, said strips being made of a dimensionally stable material, of polyethylene for example, having a thickness of approximately 0.8 mm for example to approximately 1 mm for example, whereby a boundary wall skin 156 consisting of a flexible material, a polyamide fabric for example, is held on said strips.

As is apparent from FIG. 8, a lower edge 160 of the boundary wall skin 156 is bent over so as to form a horizontal fixing strip 144 which consists of a double layer of the flexible material, and it is then fed upwardly on the front surface of the boundary wall 128 to beyond the height of a lower support strip 158 where the lower edge 160 of the boundary wall skin 156 is sewn to the flexible material of the vertical lower portion 130 of the boundary wall 128.

Furthermore, the two layers of the fixing strip 144 and the base 142 of the dirt collecting compartment body 140 are sewn together so that the lower support strip 158 is enclosed in a pocket which is formed by the boundary wall skin 156 and is closed by means of the stitches.

In a corresponding manner, the upper edge 162 of the boundary wall skin 152 is wrapped around an upper support strip 164 of the support frame and then sewn to the inclined upper portion 132 of the boundary wall 128 so that the upper support strip 164 is also enclosed in a pocket which is formed by the boundary wall skin 156 and is closed by means of stitching.

Finally, the support frame 152 also comprises a central support strip 166 which is arranged at the upper edge of the vertical lower portion 130 of the boundary wall 128 and is held there by adhering it or sewing it to the flexible material of the boundary wall skin 156.

The support strips 154 of the support frame 152 cater for adequate mechanical stability of the boundary wall 128. Since these support strips 154 are movable relative to one another, the flexibility of the boundary walls 128 of the dirt collecting compartment body 140 is increased relative to that of the previously described fourth embodiment when this arrangement is rolled up.

Otherwise, the fifth embodiment of the dirt collecting compartments 126 corresponds exactly to the fourth embodiment in regard to the construction and manner of functioning thereof, so that reference may be made in these respects to the preceding description.

A sixth embodiment of the dirt collecting compartments 126 which is illustrated in FIG. 9 differs from the previously described fifth embodiment in that the dirt collecting compartments 126 are not formed by a dirt collecting compartment body 140 which is stationary on the base 124 of the trough 104 of the dip tank 100, but rather, in that they are formed by a dirt collecting compartment body 140 in the form of an endless belt that is movable through the bath 106.

As is apparent from FIG. 9, the dirt collecting compartment body 140 of the sixth embodiment in the form of an endless belt is tensioned over a drive roller 168, two guide rollers 170 arranged within the bath 106 and a plurality of guide rollers 172 arranged outside the bath 106.

Dirt collecting compartments 126 bounded by the base 142 and the boundary walls 128 as well as the (not illustrated in FIG. 9) side walls 138 of the dirt collecting compartment body 140 are formed along the entire dirt collecting compartment body 140.

The dirt collecting compartments 126 located between the guide rollers 170 arranged in the bath 106 form a dirt collecting section 174 of the dirt collecting compartment body 140 in which dirt particles sediment from the bath 106 during the operation of the dip tank 100.

Following a predetermined operational period in which a certain quantity of dirt particles has collected in the dirt collecting section 174, the drive roller 168 is set into rotation in the direction indicated in FIG. 9 by the arrow 176 by means of a (not illustrated) rotary device whereby the

dirt collecting compartment body 140 is caused to circulate until the dirt collecting compartment body 140 in the form of an endless belt has moved forward by approximately the length of the dirt collecting section 174 so that the dirt collecting section 174 is now formed by new dirt collecting compartments 126 which have not yet been filled with sedimented dirt particles.

During the circulatory movement of the dirt collecting compartment body 140, the dirt collecting compartments 126 located in an emptying section 178 are simultaneously emptied into a dirt collecting container 180.

The dirt collecting compartments 126 that have been emptied in this way can then re-enter the dirt collecting section 174 after a certain number of sedimentation and further movement cycles where they can then be refilled with dirt particles.

As an alternative to such a step-by-step movement of the dirt collecting compartment body 140, the latter could also be moved continuously through the bath 106 at an appropriately slower speed of displacement.

In this embodiment, the dirt collecting compartment body 140 must have a base 142 and side walls 138 of a sufficiently flexible material as to enable it to be threaded over the guide rollers 170, 172 and the drive shaft 168.

Such dirt collecting compartment bodies 140 as have been described hereinabove in connection with the fourth and fifth embodiments are suitable for this purpose.

Rather than an endless belt as shown in FIG. 9, a dirt collecting compartment body 140 in the form of a flexible disposable belt could also be used, said belt being moved section-by-section into, and then out from, the dirt collecting section 174.

Otherwise, the sixth embodiment of the dirt collecting compartments 126 corresponds exactly to the fifth embodiment, so that reference may be made in this respect to the preceding description.

The present disclosure relates to the subject matter disclosed in German Patent Application No. 100 23 024.5 of May 11, 2000, the entire specification of which is incorporated herein by reference.

1. A tank for accommodating a fluid used for the surface treatment of work pieces, especially vehicle bodies, wherein the tank comprises dirt collecting compartments which are arranged in the base region of the tank.

2. A tank in accordance with claim 1, wherein the tank is in the form of a dip tank for immersing the work pieces, especially the vehicle bodies.

3. A tank in accordance with claim 1, wherein the tank is in the form of a return tank for a dip tank through which the fluid contained in the dip tank is continuously or discontinuously circulated.

4. A tank in accordance with claim 1, wherein the dirt collecting compartments are bounded by boundary walls extending transversely to the longitudinal direction of the tank.

5. A tank in accordance with claim 4, wherein the boundary walls are in the form of partition walls which respectively separate two mutually successive dirt collecting compartments in the longitudinal direction of the tank.

6. A tank in accordance with claim 4, wherein the boundary walls comprise an upper portion which is inclined to the horizontal and inclined to the vertical.

7. A tank in accordance with claim 6, wherein in that the upper portion is inclined to the horizontal at an angle of approximately 20° to approximately 80°, preferably at an angle of approximately 30° to approximately 70°, and especially at an angle of approximately 40° to approximately 60°.

8. A tank in accordance with claim 4, wherein the boundary walls comprise a vertical lower portion.

9. A tank in accordance with claim 4, wherein the boundary walls are fixed to the base of the tank.

10. A tank in accordance with claim 4, wherein the boundary walls are releasably attached to the base of the tank.

11. A tank in accordance with claim 10, wherein the tank comprises mountings into which the boundary walls are insertable.

12. A tank in accordance with claim 4, wherein the tank is provided with a dirt collecting compartment body which comprises the boundary walls and connecting elements by means of which the boundary walls are connected together.

13. A tank in accordance with claim 12, characterised in that the dirt collecting compartment body (140) comprises a base (142).

14. A tank in accordance with claim 12, wherein the dirt collecting compartment body is removable from the tank.

15. A tank in accordance with claim 12, wherein the dirt collecting compartment body is made of a synthetic material, for example, of polyvinyl chloride or polypropylene.

16. A tank in accordance with claim 12, wherein the dirt collecting compartment body is made of a disposable material.

17. A tank in accordance with claim 12, wherein the dirt collecting compartment body comprises a flexible material, for example, polyamide.

18. A tank in accordance with claim 17, wherein the dirt collecting compartment body comprises a base consisting of a flexible material and dimensionally stable boundary walls consisting of polyethylene for example.

19. A tank in accordance with claim 17, wherein the dirt collecting compartment body comprises a support frame consisting of polyethylene for example.

20. A tank in accordance with claim 17, wherein the dirt collecting compartment body is adapted to be rolled up.

21. A tank in accordance with claim 17, wherein the dirt collecting compartment body is in the form of a flexible belt and the tank comprises a movement inducing device for moving the dirt collecting compartment body through the tank.

22. A tank in accordance with claim 21, wherein the dirt collecting compartment body is in the form of an endless belt.

23. A dirt collecting compartment body for disposition in the base region of a tank for accommodating a fluid used for the surface treatment of work pieces, especially vehicle bodies, comprising boundary walls, which bound dirt collecting compartments, and connecting elements by means of which the boundary walls are connected together.

24. A dirt collecting compartment body in accordance with claim 23, wherein the boundary walls extend transversely to a longitudinal direction of the dirt collecting compartment body.

25. A dirt collecting compartment body in accordance with claim 23, wherein the boundary walls are in the form of partition walls which respectively separate two mutually successive dirt compartments in the longitudinal direction of the dirt collecting compartment body.

26. A dirt collecting compartment body in accordance with claim 23, wherein the boundary walls comprise an upper portion which is inclined to the horizontal and inclined to the vertical when the dirt collecting compartment body is disposed in the tank.

27. A dirt collecting compartment body in accordance with claim 26, wherein the upper portion is inclined to the horizontal at an angle of approximately 20° to approximately 80°, preferably at an angle of approximately 30° to approximately 70°, and especially at an angle of approximately 40° to approximately 60° when the dirt collecting compartment body is disposed in the base region of the tank.

28. A dirt collecting compartment body in accordance with claim 23, wherein the boundary walls comprise a vertical lower portion.

29. A dirt collecting compartment body in accordance with claim 23, wherein the dirt collecting compartment body comprises a base.

30. A dirt collecting compartment body in accordance with claim 23, wherein the dirt collecting compartment body is removable from the tank.

31. A dirt collecting compartment body in accordance with claim 23, wherein the dirt collecting compartment body is made of a synthetic material, for example, of polyvinyl chloride or polypropylene.

32. A dirt collecting compartment body in accordance with claim 23, wherein the dirt collecting compartment body is made of a disposable material.

33. A dirt collecting compartment body in accordance with claim 23, wherein the dirt collecting compartment body comprises a flexible material, for example, polyamide.

34. A dirt collecting compartment body in accordance with claim 33, wherein the dirt collecting compartment body comprises a base consisting of a flexible material and dimensionally stable boundary walls consisting of polyethylene for example.

35. A dirt collecting compartment body in accordance with of claim 33, wherein the dirt collecting compartment body comprises a support frame consisting of polyethylene for example.

36. A dirt collecting compartment body in accordance with claim 33, wherein the dirt collecting compartment body is adapted to be rolled up.

37. A dirt collecting compartment body in accordance with claim 33, wherein the dirt collecting compartment body is in the form of an endless belt.
